(19) United States
(12) Patent Application Publication
(10) Pub. No.: US 2025/0345974 A1
(43) Pub. Date: Nov. 13, 2025

(54) METHOD OF MANUFACTURING TRANSMISSION COVER FOR LIDAR SENSOR

(71) Applicants: Hyundai Motor Company, Seoul (KR); Kia Corporation, Seoul (KR); Ecoplastic Corporation, Gyeongju-si (KR)

(72) Inventors: Seon-Yong An, Hwaseong-si (KR); Kyoung-Chun Kweon, Hwaseong-si (KR); Gyeom-Son Seong, Gunpo-si (KR); Wan-Ho Son, Gunpo-si (KR); Tai-Won Kim, Gyeongju-si (KR)

(21) Appl. No.: 18/942,075

(22) Filed: Nov. 8, 2024

(30) Foreign Application Priority Data
May 13, 2024 (KR) 10-2024-0062603

(51) Int. Cl. B29C 45/16; B29C 45/00; B29C 45/14; B29C 45/26; B29C 45/70; B29K 69/00; B29K 75/00; B29L 31/30; B32B 27/08; B32B 27/36; B32B 27/40; G01S 7/481; G01S 17/931

(52) U.S. Cl. CPC B29C 45/1679; B29C 45/1671; B29C 45/2681; B29C 45/70; B32B 27/08; B32B 27/365; B32B 27/40; G01S 7/4813; G01S 17/931; B29C 2045/0079; B29C 45/14008; B29C 2045/14868; B29K 2069/00; B29K 2075/00; B29K 2995/0027; B29L 2031/30; B32B 2255/10; B32B 2307/412; B32B 2307/762; B32B 2571/00; B32B 2605/00

(57) ABSTRACT

A method of manufacturing a transmission cover for a LiDAR sensor can include preforming a film layer configured to transmit infrared rays in a specific wavelength range, inserting the film layer into a mold and molding a first injection molded product in which the film layer bonded to a base layer by injection a base layer material into the mold. The transmission cover for a LiDAR sensor can be capable of implementing a three-dimensional exterior design with 2D and 3D shapes, while maintaining functionality of the sensor through the use of an infrared transmission film.

### CROSS-REFERENCE TO RELATED APPLICATIONS

This application claims priority to Korean Patent Application No. 10-2024-0062603, filed on May 13, 2024, which is incorporated herein by reference in its entirety.

### TECHNICAL FIELD

The present disclosure relates to a method of manufacturing a transmission cover for a Light Detection and Ranging (LiDAR) sensor.

### BACKGROUND

With the recent increasing importance of autonomous driving, LiDAR units are installed in vehicles to detect obstacles around the vehicle.

The LiDAR unit emits infrared light to detect objects based on light reflected from objects in front and is typically positioned at the front and on the top of the vehicle.

Covers for a LiDAR sensor primarily focus on simple protective function, and these covers are often made of plastic, glass, or other materials.

However, due to technical and manufacturing limitations, the cover for a LiDAR sensor is not fully integrated into vehicle design. Additionally, limited material options available for the cover make it difficult to improve performance degradation caused by environmental factors.

Therefore, the conventional cover for a LiDAR sensor is vulnerable to environmental factors such as temperature changes, humidity, and physical impacts, which may degrade long-term performance and reliability.

Furthermore, the cover design often fails to harmonize with the vehicle's exterior and does not meet the design requirements of automotive manufacturers.

The information disclosed in this Background section is only for enhancement of understanding of the general background of the disclosure and therefore it may contain information that does not form the prior art that is already publicly known, available, or in-use. Korean Patent Application Publication No. 10-2023-0083012 discloses subject matter that is related to the subject matter disclosed herein.

### SUMMARY

Various embodiments are directed to a method of manufacturing a transmission cover for a Light Detection and Ranging (LiDAR) sensor capable of implementing a three-dimensional exterior design with 2D and 3D shapes, while maintaining functionality of the sensor through the use of an infrared transmission film.

In an embodiment of the present disclosure, a method of manufacturing a transmission cover for a LiDAR sensor can include preforming a film layer configured to transmit infrared rays in a specific wavelength range, inserting the film layer into a mold and molding a first injection molded product in which the film layer is bonded to a base layer by injecting a base layer material into the mold.

The preforming can include molding the film layer into a three-dimensional shape by press molding. The preforming can include molding the film layer with a specific pattern. The performing may further include forming a protective layer on the film layer of the first injection molded product.

The protective layer can be made of polyurethane (PU). The base layer can be made of polycarbonate (PC).

The inserting of the film layer into a mold may include inserting the film layer into a cavity between a first mold and a rotary mold, and the molding of the first injection molded product may include injecting the base layer material into the cavity between the first mold and the rotary mold.

The forming of the protective layer may include rotating the rotary mold to position the film layer facing a second mold disposed opposite the first mold, and inserting a protective layer material in a cavity between the second mold and the rotary mold to coat the protective layer on the film layer.

The inserting the film layer into a mold may include inserting the film layer into a cavity between a first mold and a second mold, and the molding of the first injection molded product may include injecting the base layer material into the cavity between the first mold and the second mold.

The forming of the first injection molded product may include closing the first mold and the second mold after injecting the base layer material.

The forming of the protective layer may include ejecting the first injection molded product and coating the protective layer on the film layer.

The forming of the first injection molded product may include inserting the film layer into a cavity between a first mold and a second mold arranged vertically, closing the first mold and the second mold, and injecting the base layer material into a cavity between the first mold and the second mold.

The forming of the protective layer may include ejecting the first injection molded product and coating the protective layer on the film layer.

The forming of the protective layer may include ejecting the first injection molded product and inserting the product into a cavity of a second mold, and injecting a protective layer material into the cavity of the second mold.

The forming of the protective layer may include ejecting the first injection molded product and spray coating a protective layer material to a surface of the film layer.

The conventional transmission cover for a LiDAR sensor is typically developed to enable only LiDAR transmission by simply applying a transparent material (such as glass, PC, or PET). This can result in very low design compatibility with surrounding components and difficulty in implementing various shapes (3D).

An embodiment of the present disclosure provide an integrated LiDAR transmission cover capable of having a metallic appearance, LiDAR transmission, and surface self-healing properties.

A desired design may be printed entirely or locally, and the use of a film can allow preforming the design into a 3D shape.

The optimized injection molding process can minimize damage to the LiDAR transmission film and printed design. The self-healing properties of the film can help prevent degradation in LiDAR transmission performance caused by micro-surface defects.

Scratches on PC may decrease LiDAR sensing performance by 20% or more. Due to the self-healing properties of PU, this problem can be addressed by molding PU on the front side and PC on the rear side, preparing for a reaction injection molding process using PC.

### BRIEF DESCRIPTION OF THE DRAWINGS

FIG. 1 schematically shows a transmission cover for a LiDAR sensor according to an embodiment of the present disclosure.

FIG. 2 shows film layers of a transmission cover according to an embodiment of the present disclosure.

FIG. 3 is a flowchart for a method of manufacturing a transmission cover for a LiDAR sensor according to an embodiment of the present disclosure.

FIG. 4 is a cross-sectional view of a transmission cover manufactured by a method of manufacturing a transmission cover for a LiDAR sensor according to an embodiment of the present disclosure.

FIGS. 5 and 6 show a comparative illustration of a state in which a film is inserted into a mold.

FIGS. 7 to 10 sequentially show a method of manufacturing a transmission cover for a LiDAR sensor according to a first embodiment of the present disclosure.

FIGS. 11 to 14 sequentially show a method of manufacturing a transmission cover for a LiDAR sensor according to a second embodiment of the present disclosure.

FIGS. 15 to 17 sequentially show a method of manufacturing a transmission cover for a LiDAR sensor according to a third embodiment of the present disclosure.

FIGS. 18 to 20 sequentially show a method of manufacturing a transmission cover for a LiDAR sensor according to a fourth embodiment of the present disclosure.

FIG. 21 sequentially shows a method of manufacturing a transmission cover for a LiDAR sensor according to a fifth embodiment of the present disclosure.

### DETAILED DESCRIPTION OF ILLUSTRATIVE EMBODIMENTS

To understand the present disclosure and advantages achieved by embodiments of the present disclosure, reference can be made to the accompanying drawings and contents illustrated in the accompanying drawings which illustrate example embodiments of the present disclosure.

In describing example embodiments of the present disclosure, known techniques or repetitive descriptions that may unnecessarily obscure the gist of the present disclosure can be reduced or omitted.

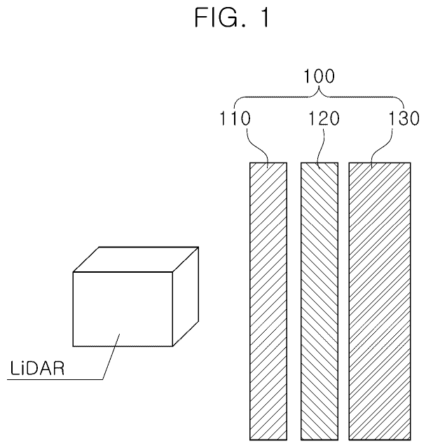

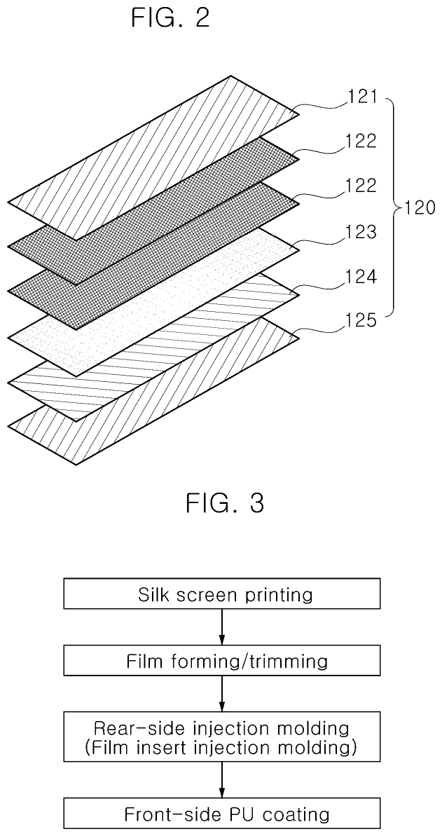

FIG. 1 schematically shows a transmission cover for a Light Detection and Ranging (LiDAR) sensor according to an embodiment of the present disclosure. FIG. 2 shows film layers of a transmission cover according to an embodiment of the present disclosure.

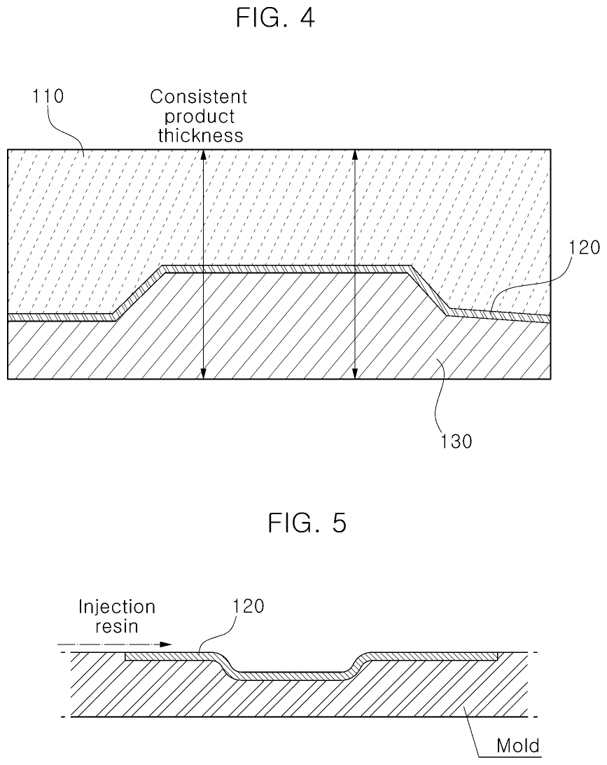

FIG. 3 is a flowchart for a method of manufacturing a transmission cover for a LiDAR sensor according to an embodiment of the present disclosure. FIG. 4 is a cross-sectional view of a transmission cover manufactured by a method of manufacturing a transmission cover for a LiDAR sensor according to an embodiment of the present disclosure.

A transmission cover for a LiDAR sensor and a method of manufacturing the same according to an example embodiment of the present disclosure will be described hereinafter with reference to FIGS. 1 to 4.

An embodiment of the present disclosure can provide a transmission cover for a LiDAR sensor, which can allow sensing LiDAR signals by selectively transmitting infrared rays in a specific wavelength range and reflecting visible light.

While functioning as the transmission cover for a LiDAR sensor, an embodiment of the present disclosure can include a film layer 120 for design implementation. This film layer 120 can be laminated onto a base layer 110 made of thermoplastic polycarbonate (PC) to improve design aspects for better compatibility with a vehicle's exterior design. The film layer 120 can be coated with a protective layer 130 to ensure protection.

The film layer 120 can function as a pattern film capable of implementing metallic colors or design patterns, including 3D shapes.

The protective layer 130 can be made of polyurethane (PU) and can exhibit self-healing properties, thereby protecting the cover from external factors such as impacts.

Polyurethane is not the only option. The protective layer 130 may also be made of other self-healing materials that provide LiDAR transmission performance of 80% or more.

When applied to a vehicle grille, for example, an embodiment of the present disclosure can achieve harmony with the vehicle design and optimize sensing performance. The use of the film layer 120 of an insert film and urethane can enhance the vehicle's exterior design while ensuring smooth operation of the LiDAR sensor.

The film layer 120 may have a multi-layer structure, as shown in FIG. 2. In this film layer 120, the bottommost layer, a PC layer 121, may be configured with metallic or other colors, and a LiDAR transmission film 124 may be included for LiDAR transmission.

An infrared (IR) printing layer 122 may be laminated to implement design patterns, and a binder layer 123 may be printed for bonding of the IR printing layer 122.

The PC layer 121 can be printed on the topmost layer, and the PC layer 121 can function as a protective material.

To form the film layer 120, an embodiment of the present disclosure can utilize processes such as reaction injection molding (RIM), injection compression molding (ICM), and vertical injection molding for insert film injection, for example. These processes can minimize issues such as gate wash, film sagging, film folding, and orange peel effect. Furthermore, potential problems during injection molding can be mitigated by protecting an infrared-transmitting metallic film with a PC film.

As shown in FIG. 3, a film can be formed using a mold and trimmed after silk screen printing is performed, thereby manufacturing the film layer 120, which can be capable of implementing patterns such as a three-dimensional uneven shape shown in FIG. 4. While having an uneven shape, the transmission cover can maintain a consistent overall thickness. The film may be pre-heated and then trimmed after implementing a three-dimensional shape by press molding.

The film can be inserted into the mold to form a first injection molded product, in which the film layer 120 can be laminated and bonded onto the base layer 110, a PC layer. The protective layer 130 can be then coated onto or injected into the film layer 120 to manufacture a transmission cover 100. In this case, film insertion in the mold can be important for insert injection molding, particularly for products with uneven shapes.

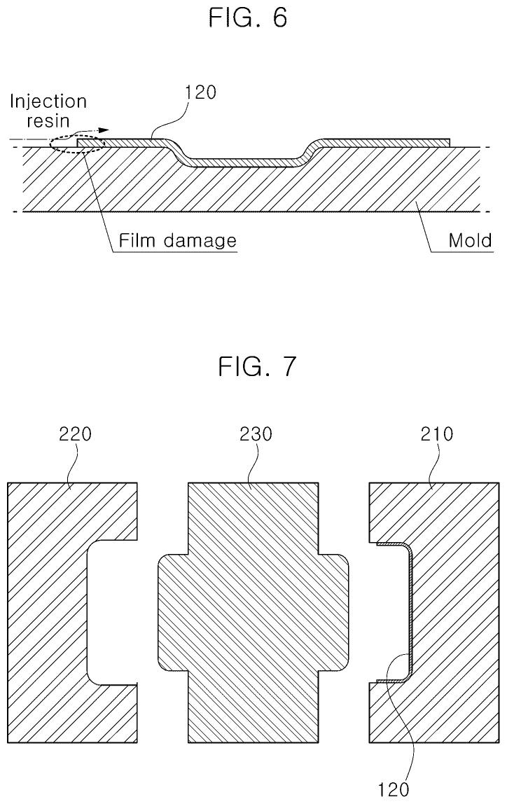

As shown in FIG. 5, the film insert structure can be configured to avoid being positioned on a path of injection resin flow. In the case of FIG. 6, the film can be undesirably positioned on the path of injection resin flow. This may result in obstruction of the injection resin flow and damage to the film, so it can be desirable to design the mold such that the entire film area is completely inserted into an insert portion to allow the film to be properly seated in the mold.

To form the film layer 120 in an embodiment of the present disclosure, processes such as RIM, ICM, and vertical injection molding may be used to prevent degradation in LiDAR transmission performance and exterior defects. However, other manufacturing methods may also be applied.

FIGS. 7 to 10 sequentially show a method of manufacturing a transmission cover for a LiDAR sensor according to a first embodiment of the present disclosure.

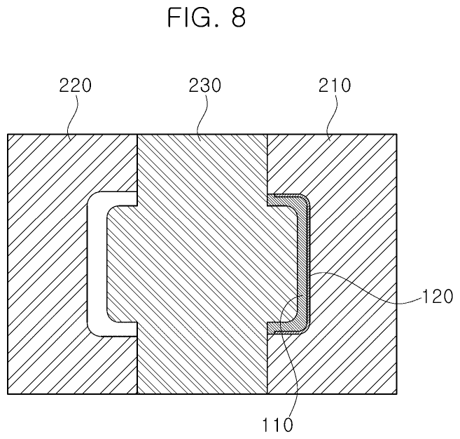

The first embodiment can be a reaction injection molding process. As shown in FIG. 7, a film layer 120 can be inserted into a cavity between a first mold 210 and a rotary mold 230. As shown in FIG. 8, a first injection molding process can be performed to form a first injection molded product, in which the film layer 120 is bonded onto a base layer 110. In this case, the film layer 120 may have a three-dimensional shape with patterns such as embossed and engraved features formed by press molding.

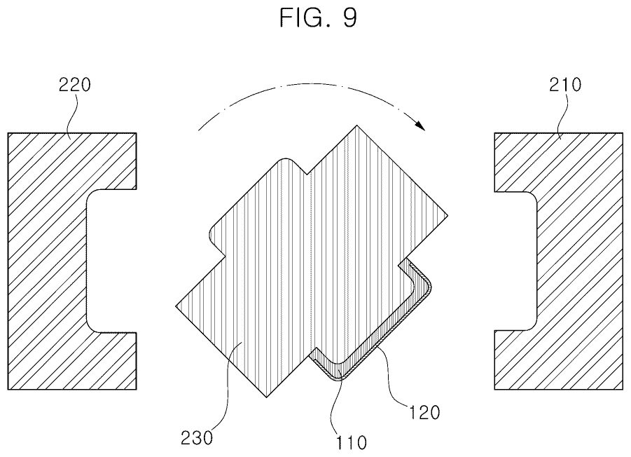

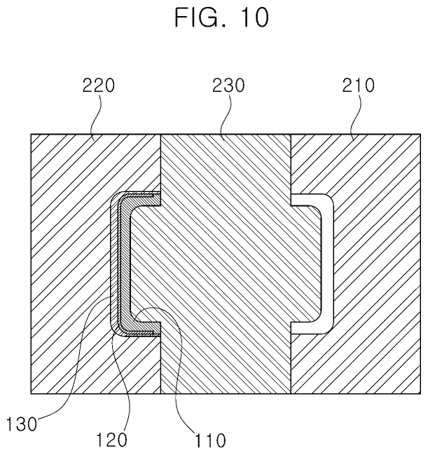

As shown in FIG. 9, the rotary mold 230 can rotate to position the film layer 120 of the first injection molded product facing a second mold 220. As shown in FIG. 10, a surface coating process can be performed through the cavity on the side of the second mold 220 to coat the film layer 120 with the protective layer 130.

During this process, mold opening and mold closing can be essential. The first mold 210 can function as an injection mold and the second mold 220 can function as a coating mold.

In the first embodiment, both injecting and coating may be performed in the mold to achieve a consistent thickness of a product. Thus, a consistent thickness of a product can ensure uniform LiDAR transmission performance. The first embodiment also can simplify the manufacturing process and reduces cost.

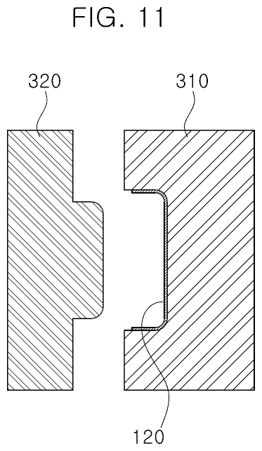

FIGS. 11 to 14 sequentially show a method of manufacturing a transmission cover for a LiDAR sensor according to a second embodiment of the present disclosure.

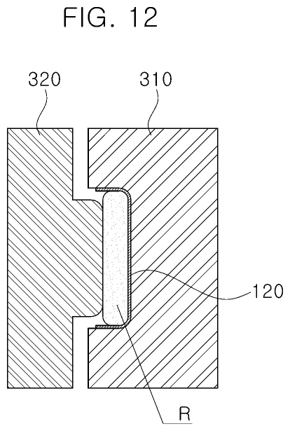

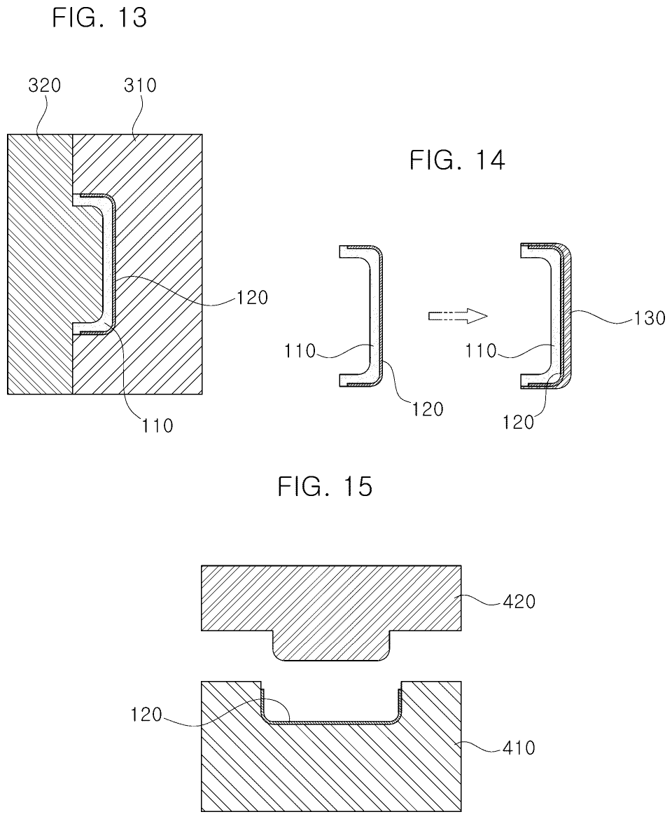

The second embodiment can be an injection compression molding process. As shown in FIG. 11, a film layer 120 can be inserted into a cavity between a first mold 310 and a second mold 320. Then as shown in FIG. 12, an injection resin R can be injected. As shown in FIG. 13, the molds can be fully closed to compress the resin R.

As shown in FIG. 14, a cover can be manufactured by ejecting a first injection molded product and coating the surface of the film layer 120 with a protective layer 130. Thus, the injection resin can be injected into a partially open mold before the mold is closed at low pressure, which can be a combination of injection molding and compression molding.

In the second embodiment, this process can minimize exterior defects (e.g., gate wash, film wrinkling, etc.) that can be caused by high injection pressure at a gate, and can reduce internal stress in a product, which can mitigate deformation.

FIGS. 15 to 17 sequentially show a method of manufacturing a transmission cover for a LiDAR sensor according to a third embodiment of the present disclosure.

The third embodiment can be a vertical injection molding process, which differs from conventional injection molding. This process of the third embodiment can allow for lower injection pressure compared to conventional injection molding due to the natural flow of resin aided by gravity.

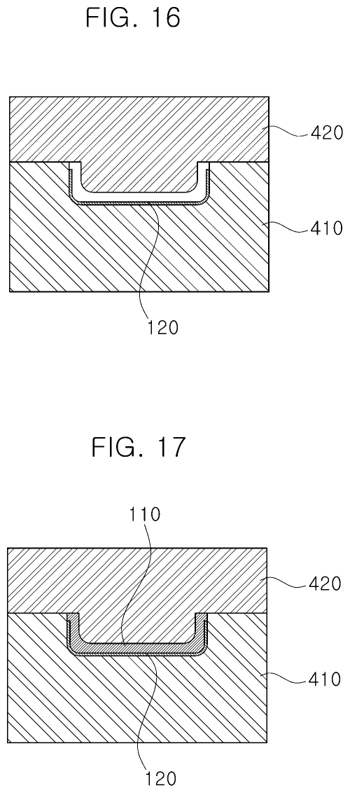

A film layer 120 can be inserted into a cavity between a first mold 410 and a second mold 420 arranged vertically, as shown in FIG. 15. Then the molds can be closed as shown in FIG. 16, and the cavity can be filled with resin at low pressure for molding, as shown in FIG. 17.

A cover can be manufactured by ejecting a first injection molded product and coating the surface of the film layer 120 with a protective layer 130.

In the third embodiment, this process can minimize exterior defects (e.g., gate wash, film wrinkling, etc.) that can be caused by high injection pressure at a gate, and can reduce internal stress in a product, which can mitigate deformation.

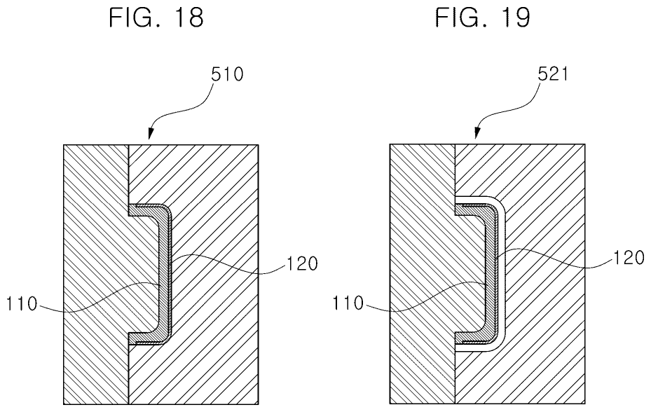

FIGS. 18 to 20 sequentially show a method of manufacturing a transmission cover for a LiDAR sensor according to a fourth embodiment of the present disclosure.

The fourth embodiment can be a two-step insert injection molding process. As shown in FIG. 18, a film layer 120 can be inserted into a cavity of a first mold 510 for molding, and then a first injection molded product can be ejected.

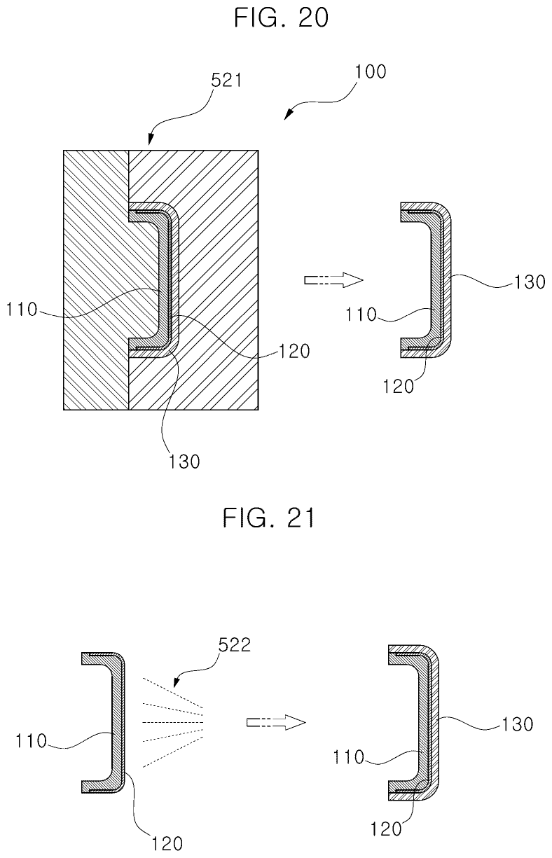

As shown in FIG. 19, the first injection molded product can be inserted into a second mold 521. As shown in FIG. 20, a second injection molding process can be performed to eject a transmission cover 100, in which a protective layer 130 can be formed on the film layer 120. In this way, both injecting and coating may be performed in the mold to achieve a consistent thickness of a product.

Alternatively, instead of the sequential first and second injection molding process, as shown in FIG. 18, spray coating 522 may be used to coat the film layer 120 of the first injection molded product with the protective layer 130, as shown in FIG. 21. This process may improve mass production efficiency and make the manufacturing process more accessible.

In the example embodiments of the present disclosure, the transmission cover for a LiDAR sensor can be manufactured as described above. Unlike the related art, the example embodiments can provide an integrated LiDAR transmission cover capable of having a metallic appearance, LiDAR transmission, and surface self-healing properties.

A desired design may be printed entirely or locally, and the use of a film can allow preforming the design into a 3D shape.

An optimized injection molding process of an embodiment can minimize damage to the LiDAR transmission film and printed design. In addition, in an embodiment, the self-healing properties of the film can help prevent degradation in LiDAR transmission performance caused by micro-surface defects.

While the present disclosure has been described with reference to the example embodiments illustrated in the drawings, those skilled in the art can understand that the present disclosure is not necessarily limited to the disclosed example embodiments but may be variously modified and arranged without departing from the technical spirit and scopes of the present disclosure. Thus, it can be understood that the present disclosure is intended to cover various modifications and arrangements within the scopes of the appended claims. Accordingly, the scopes of the present disclosure can be defined by following claims.

What is claimed is:

1. A method of manufacturing a transmission cover for a Light Detection and Ranging (LiDAR) sensor, the method comprising:
preforming a film layer configured to transmit infrared rays in a specific wavelength range;
inserting the film layer into a mold structure; and
molding a first injection molded product in which the film layer is bonded to a base layer by injecting a base layer material into the mold structure.

2. The method of claim 1, wherein the preforming comprises molding the film layer into a three-dimensional shape by press molding.

3. The method of claim 2, wherein the preforming comprises molding the film layer with a specific pattern.

4. The method of claim 2, further comprising forming a protective layer on the film layer of the first injection molded product.

5. The method of claim 4, wherein the protective layer is made of polyurethane.

6. The method of claim 4, wherein the base layer is made of polycarbonate.

7. The method of claim 4, wherein the inserting of the film layer into the mold structure comprises inserting the film layer into a first cavity between a first mold and a rotary mold of the mold structure; and
wherein the molding of the first injection molded product comprises injecting the base layer material into the first cavity between the first mold and the rotary mold.

8. The method of claim 7, wherein the forming of the protective layer comprises:
rotating the rotary mold to position the film layer facing a second mold disposed opposite the first mold; and
inserting a protective layer material in a second cavity between the second mold and the rotary mold to coat the protective layer on the film layer.

9. The method of claim 4, wherein the inserting of the film layer into the mold structure comprises inserting the film layer into a cavity between a first mold and a second mold of the mold structure; and
wherein the molding of the first injection molded product comprises injecting the base layer material into the cavity between the first mold and the second mold.

10. The method of claim 9, wherein the forming of the first injection molded product further comprises closing the first mold and the second mold after injecting the base layer material.

11. The method of claim 9, wherein the forming of the protective layer comprises ejecting the first injection molded product and coating the protective layer on the film layer after the ejecting of the first injection molded product.

12. The method of claim 4, wherein the forming of the first injection molded product comprises:
inserting the film layer into a cavity between a first mold and a second mold arranged vertically;
closing the first mold and the second mold; and injecting the base layer material into the cavity between the first mold and the second mold.

13. The method of claim 12, wherein the forming of the protective layer comprises ejecting the first injection molded product and coating the protective layer on the film layer after the ejecting of the first injection molded product.

14. The method of claim 4, wherein the forming of the protective layer comprises:
ejecting the first injection molded product and inserting the product into a cavity of a second mold; and
injecting a protective layer material into the cavity of the second mold.

15. The method of claim 4, wherein the forming of the protective layer comprises ejecting the first injection molded product and spray coating a protective layer material to a surface of the film layer after the ejecting of the first injection molded product.

16. A method of manufacturing a transmission cover for a Light Detection and Ranging (LiDAR) sensor, the method comprising:
preforming a film layer, wherein the film layer is configured to transmit infrared rays;
inserting the film layer into a mold structure; and
molding a first injection molded product in which the film layer is bonded to a base layer by injecting a base layer material into the mold structure; and
forming a protective layer on the film layer of the first injection molded product, wherein the protective layer is made of polyurethane.

17. The method of claim 16, wherein the preforming comprises molding the film layer into a three-dimensional shape by press molding.

18. The method of claim 16, wherein the preforming comprises molding the film layer with a specific pattern.

19. A method of manufacturing a transmission cover for a Light Detection and Ranging (LiDAR) sensor, the method comprising:
molding a film layer into a three-dimensional shape by press molding the film layer, wherein the film layer is configured to transmit infrared rays;
inserting the film layer into a mold structure; and
molding a first injection molded product in which the film layer is bonded to a base layer by injecting a base layer material into the mold structure; and
forming a protective layer on the film layer of the first injection molded product, wherein the protective layer is made of polyurethane.

20. The method of claim 19, wherein the inserting of the film layer into the mold structure comprises inserting the film layer into a first cavity between a first mold and a rotary mold;
wherein the molding of the first injection molded product comprises injecting the base layer material into the first cavity between the first mold and the rotary mold; and
wherein the forming of the protective layer on the film layer comprises:
rotating the rotary mold to position the film layer facing a second mold disposed opposite the first mold, and
inserting a protective layer material in a second cavity between the second mold and the rotary mold to coat the protective layer on the film layer.
